(19) United States
(12) Patent Application Publication
(10) Pub. No.: US 2026/0031530 A1
(43) Pub. Date: Jan. 29, 2026

(54) ARRAY ANTENNA FOR REDUCING GRATING LOBE AND CROSS POLARIZATION LEAKAGE

(71) Applicant: Hanwha NxMD Corporation, Seongnam-si (KR)

(72) Inventors: Seo Hwan JEONG, Suwon-si (KR); Yun Mo KANG, Gwacheon-si (KR); Hyun Joo PARK, Seoul (KR)

(21) Appl. No.: 18/917,929

(22) Filed: Oct. 16, 2024

(30) Foreign Application Priority Data
Jul. 25, 2024 (KR) 10-2024-0098298

(51) Int. Cl. H01Q 1/52; H01Q 9/04; H01Q 21/06

(52) U.S. Cl. CPC H01Q 1/521; H01Q 9/0414; H01Q 21/065

(57) ABSTRACT

Disclosed is an array antenna for reducing grating lobe and cross polarization leakage. The array antenna includes a plurality of first element units disposed in a first column, each of the first element units including two elements having a specific distance that differs from the distance (dy) of one element by a predetermined value and a plurality of second element units disposed in a second column adjacent to the first column, each of the second element units including two elements having the specific distance, the second element units being disposed spaced apart from the first element units by the distance (dy) of one element, the first element units and the second element units being alternately and repeatedly disposed in a row direction, wherein each of the first and second element units includes one or more dummy patches configured to have no electrical signal connection.

### CROSS-REFERENCE

Pursuant to 35 U.S.C. § 119(a), this application claims the benefit of Korean Patent Application No. 2024-0098298, filed on Jul. 25, 2024, which is hereby incorporated by reference as if fully set forth herein.

### BACKGROUND

### Field

The present disclosure relates to an array antenna for multiple-input multiple-output (MIMO) transmission and reception, and more particularly to an array antenna having a configuration for reducing a grating lobe and cross polarization leakage.

### Discussion of the Related Art

A phased array antenna, or simply an array antenna, is based on the principle of arranging a plurality of antenna elements in one dimension or space and then electrically controlling the phase of each element through a phase shifter that regulates the phase of each element, thereby enabling rapid control of the direction of the synthesized beam, and has various advantages, such as enabling reliable, rapid, and accurate direction by controlling the phase of the antenna array independent of mechanical drive to direct the beam.

Due to these advantages, in addition to improving the directional speed of radar beams mounted on fighter planes and ships, it has recently been increasingly used as a transmitting and receiving antenna of synthetic aperture radar (SAR) for aircrafts and satellites and as relay technology for mobile communication.

FIG. 1 is a view illustrating the concept of a grating lobe that may occur in an array antenna.

Referring to FIG. 1, FIGS. 1(a) and 1(b) are views showing a beam pattern, i.e., antenna directivity, wherein FIG. 1(a) shows a beam pattern in which only a main lobe 5 is formed without a grating lobe 6 as a normal beam pattern and FIG. 1(b) shows a poor beam pattern in which grating lobes 6 are formed on both sides of the main lobe 5.

When the grating lobes 6 occur in the beam pattern, a steering beam is output in an undesired direction, causing the gain of the steering beam to be output in a desired direction to drop and causing the beam to be emitted in an undesired direction.

FIG. 2 is a view illustrating the concept of MIMO communication and cross polarization leakage.

Specifically, FIG. 2(a) is a view showing a 2T2R transmit/receive structure during MIMO transmission and reception, which is a structure that uses two antennas for each of transmission and reception, theoretically doubling the data throughput compared to single antenna communication.

That is, in MIMO communication using two transmit and receive antennas, data payload may be split for each of the two antennas and transmitted over the same frequency band, wherein isolation between the antennas may be an important performance metric.

FIG. 2(b) shows the concept of separating the two transmit and receive antennas using orthogonal polarization. The orthogonal polarization enables a single emitter to be used as two independent antennas.

Depending on circumstances, however, a signal of first polarization POL_1 may be mixed with a signal of second polarization POL_2, and the degree to which the orthogonal polarization is misaligned is referred to as cross polarization leakage.

### SUMMARY

The present disclosure is to address at least the above-mentioned problems and/or disadvantages and to provide at least the advantages described below. Accordingly, an object of the present disclosure is to provide an array antenna having a configuration for reducing a grating lobe and cross polarization leakage.

Another object of the present disclosure is to provide a configuration for analyzing specific causes of cross polarization leakage and solving each cause.

Objects of the present disclosure are not limited to the aforementioned objects, and other unmentioned objects will be clearly understood by a person having ordinary skill in the art to which the present disclosure pertains based on the following description.

In an aspect, an array antenna includes a plurality of first element units disposed in a first column, each of the plurality of first element units including two elements having a specific distance that differs from the distance (dy) of one element by a predetermined value and a plurality of second element units disposed in a second column adjacent to the first column, each of the plurality of second element units including two elements having the specific distance, the plurality of second element units being disposed spaced apart from the plurality of first element units by the distance (dy) of one element, the plurality of first element units and the plurality of second element units being alternately and repeatedly disposed in a row direction, wherein each of the first and second element units includes one or more dummy patches configured to have no electrical signal connection.

Each of the two elements of each of the first and second element units may include the one or more dummy patches.

The dummy patches may include first type dummy patches symmetrically disposed at positions space apart from a patch for antenna connection by a predetermined distance in a column direction in each of the two elements and second type dummy patches disposed symmetrically in the column direction on a per-element unit basis in each of the first and second element units.

Meanwhile, each of the first and second element units may include a multilayer board, a first patch disposed in at least one first layer of the multilayer board for electrical signal connection to a first polarization (POL_1) antenna and a second polarization (POL_2) antenna, and a staggered via disposed so as to connect the first layer to at least one second layer of the multilayer board.

The one or more dummy patches may include a second patch spaced apart from the first patch by a predetermined distance.

The multiple layers may include a core layer located between the first layer and the second layer, and the staggered via may include a first via formed in the core layer and a second via formed at a position spaced apart from the first via by a predetermined distance in a layer direction.

The second patch may be configured such that the difference between a waveform peak of the first polarization antenna and a waveform peak of the second polarization antenna observed at the first polarization antenna is equal to or greater than a predetermined threshold.

In another aspect, an array antenna includes a plurality of first element units disposed in a first column, each of the plurality of first element units including two elements, and a plurality of second element units disposed in a second column adjacent to the first column, each of the plurality of second element units including two elements, the plurality of second element units being disposed spaced apart from the plurality of first element units by a predetermined distance, the plurality of first element units and the plurality of second element units being alternately and repeatedly disposed in a row direction, wherein each of the two elements constituting each of the first and second element units includes a first patch for antenna connection, first type dummy patches symmetrically disposed at positions space apart from the first by a predetermined distance in a column direction, and second type dummy patches disposed symmetrically in the column direction on a per-element unit basis.

In this case, the predetermined distance may correspond to the distance (dy) of one element; however, the present disclosure is not limited thereto. In another embodiment, a first distance greater by a predetermined offset than the distance (dy) of one element and a second distance less by the predetermined offset than the distance (dy) of one element may be alternately applied as the predetermined distance.

In addition, the two elements constituting each of the first and second element units may be disposed spaced apart from each other by a distance that differs from the distance (dy) of one element by a predetermined value, or may be disposed spaced apart from each other by a distance of one element.

In this case, each of the first and second element units may include a multilayer board and a staggered via, and the first type dummy patches may be configured to reduce a cross waveform between polarization antennas caused by the staggered via to a predetermined threshold or less.

### BRIEF DESCRIPTION OF THE DRAWINGS

The accompanying drawings, which are included to provide a further understanding of the disclosure and are incorporated in and constitute a part of this application, show embodiment(s) of the disclosure and together with the description serve to explain the principle of the disclosure. In the drawings:

FIG. 1 is a view illustrating the concept of a grating lobe that may occur in an array antenna;

FIG. 2 is a view illustrating the concept of MIMO communication and cross polarization leakage;

FIG. 3 is a view illustrating a 1×2 sub-array structure utilized in an embodiment of the present disclosure;

FIG. 4 is a view illustrating an overall element size offset application structure utilized in the embodiment of the present disclosure;

FIGS. 5 and 6 are views illustrating an element unit-based offset application structure utilized in the embodiment of the present disclosure;

FIG. 7 is a view illustrating a structure further including a dummy patch in accordance with a preferred embodiment of the present disclosure;

FIGS. 8 and 9 are views illustrating the reason that a staggered via is used in a PCB board for array antennas;

FIG. 10 is a view illustrating the reason that cross polarization leakage occurs due to the staggered via;

FIG. 11 is a view illustrating an antenna structure for preventing cross polarization leakage in accordance with an embodiment of the present disclosure;

FIGS. 12 and 13 are views illustrating in detail the structure of the embodiment described in FIG. 11;

FIGS. 14 and 15 are views illustrating the effect of the structure including the dummy patch described with reference to FIG. 11;

FIGS. 16 to 20 are views illustrating a structure in which the embodiment proposed through FIG. 7 is combined with the embodiment proposed through FIG. 11; and

FIG. 21 is a view illustrating the concept of adjusting the distance between antenna element units in accordance with another embodiment of the present disclosure.

### DETAILED DESCRIPTION

Now, embodiments of the present disclosure will be described in detail with reference to the accompanying drawings such that the embodiments of the present disclosure can be easily implemented by a person having ordinary skill in the art to which the present disclosure pertains. However, the present disclosure may be implemented in many different forms and is not limited to the embodiments described herein. In order to clearly illustrate the present disclosure in the drawings, parts not pertinent to the description have been omitted, and similar parts throughout the specification have been designated by similar reference numerals.

When a part is said to “include” a component throughout the specification, this means that other components are not excluded but may be further included, unless mentioned otherwise.

As described above, an aspect of the present disclosure proposes an array antenna having a configuration for reducing a grating lobe and cross polarization leakage. To this end, a 1×2 element unit-based or sub-array-based array antenna emphasizing an azimuth steering function, among array antennas, will first be described.

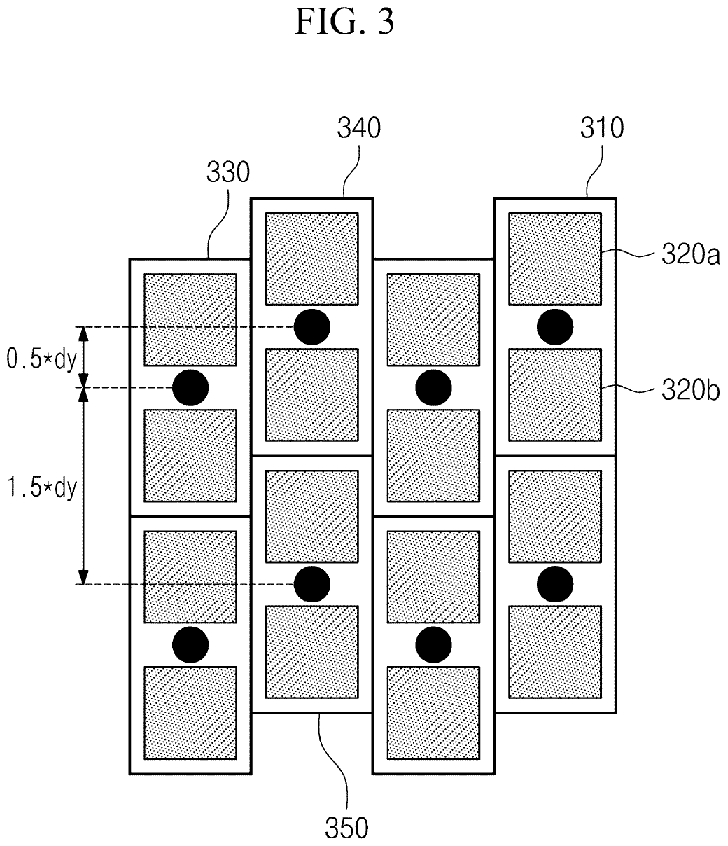

FIG. 3 is a view illustrating a 1×2 sub-array structure utilized in an embodiment of the present disclosure.

In MIMO communication utilizing array antennas, the steering direction of a beam may be such that steering in an azimuth direction is more important than steering in an elevation direction. This is because most communications are performed in a similar plane.

To this end, it is advantageous for the array antenna to have a 1×2 sub-array structure. That is, as shown in FIG. 3, one element unit 310 may include two elements 320a and 320b.

Meanwhile, in a general 1×2 sub-array structure, element units 310 in each column may be disposed spaced apart from each other in the unit of columns, as shown in FIG. 3. That is, on the assumption that the distance corresponding to the size of one element in a column direction is an “element distance dy,” element units in a second column may be repeatedly disposed spaced apart from element units in a first column by 0.5*dy.

FIG. 3 shows that the center of an element unit 330 disposed in the first column is disposed spaced apart from the center of an element unit 340 disposed in the second column adjacent thereto by 0.5*dy and is disposed spaced apart from the center of a subsequent element unit 350 disposed in the second column by 1.5*dy.

However, in the case of a half element size offset application structure, as shown in FIG. 3, the number of elements that can be arranged may be reduced, which may result in a reduction in the gain of the array antenna by a certain level.

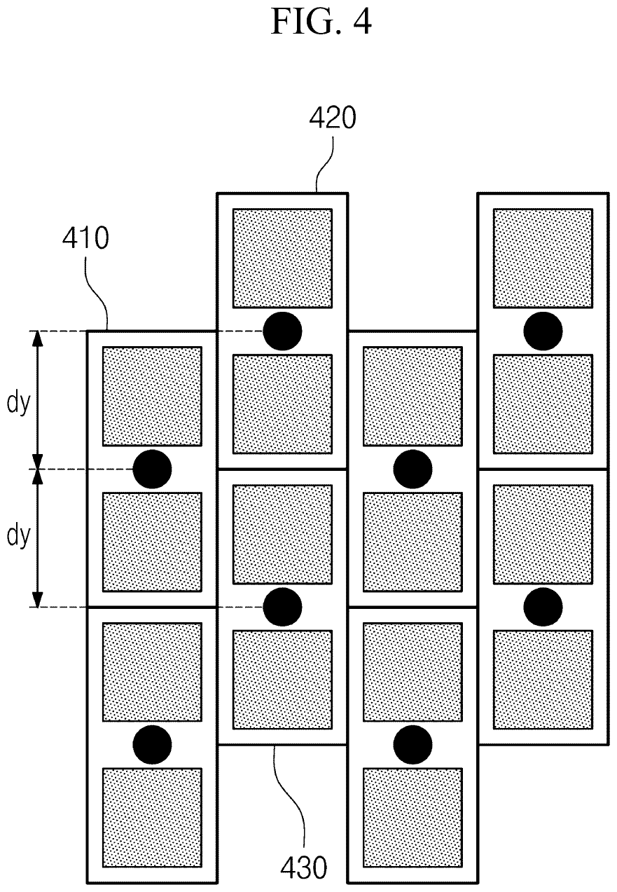

FIG. 4 is a view illustrating an overall element size offset application structure utilized in the embodiment of the present disclosure.

The array antenna structure of FIG. 4 is a structure in which the offset between the center of a first column element unit and the center of a second column element unit is dy, rather than 0.5*dy, unlike the array antenna structure of FIG. 3.

Specifically, FIG. 4 shows that the center of an element unit 410 disposed in a first column is disposed spaced apart from the center of an element unit 420 disposed in a second column adjacent thereto by dy is also disposed spaced apart from the center of a subsequent element unit 430 disposed in the second column by dy

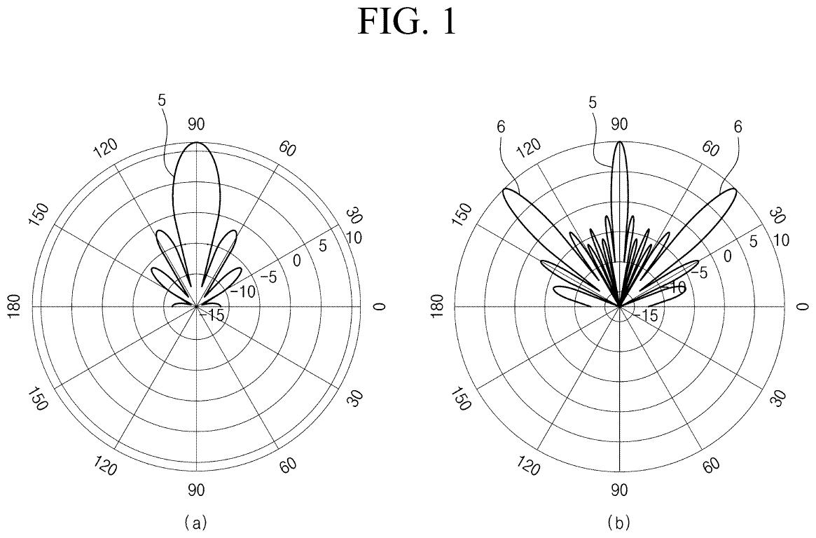

When the overall element size offset is applied, as shown in FIG. 4, the gain of the array antenna may be increased by preventing a reduction in the number of elements that can be arranged, unlike FIG. 3. However, there is a problem that the distance between the antenna elements disposed in this manner is changed, whereby the grating lobe described with reference to FIG. 1 occurs.

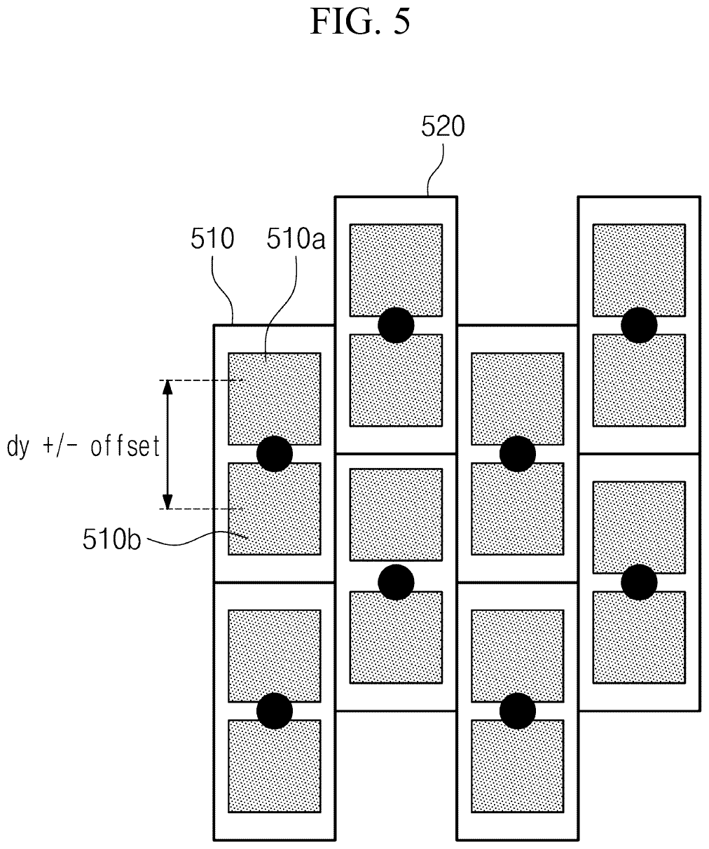

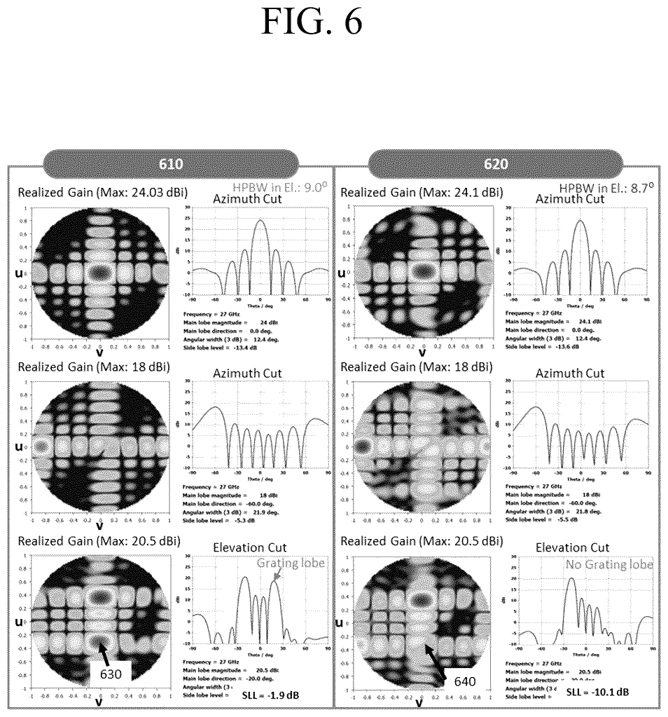

FIGS. 5 and 6 are views illustrating an element unit-based offset application structure utilized in the embodiment of the present disclosure.

Specifically, the array antenna structure shown in FIG. 5 is identical to the structure of FIG. 4 in that the center of an element unit 510 disposed in a first column is disposed spaced apart from the center of an element unit 520 disposed in a second column adjacent thereto by dy.

However, the array antenna according to the embodiment shown in FIG. 5 utilizes a structure in which two elements 510a and 510b in one element unit 510 are disposed spaced apart from each other by a specific distance (i.e., dy+/−offset) that differs from the distance dy of one element by a predetermined value, thereby preventing a grating lobe.

The grating lobe is a phenomenon that generally occurs when the distance between the antenna elements increases, and it can be seen that, when an offset is applied to the distance between the elements in one element unit 510, as shown in FIG. 5, the grating lobe is reduced, as shown in FIG. 6.

Specifically, in FIG. 6, reference numeral 610 is a view showing the performance of the structure in which an offset is applied by the distance dy of one element per element unit, as shown in FIG. 4, and reference numeral 620 is a view showing the performance of the structure in which an offset is applied to the distance between the elements in the element unit, as shown in FIG. 5.

As described above, it can be seen that the most problematic part of the grating lobe is a grating lobe 630 observed when steering in the elevation direction, and it can be seen that the grating lobe is suppressed (640) using the structure in which the offset is applied between the elements in the element unit, as shown in FIG. 5.

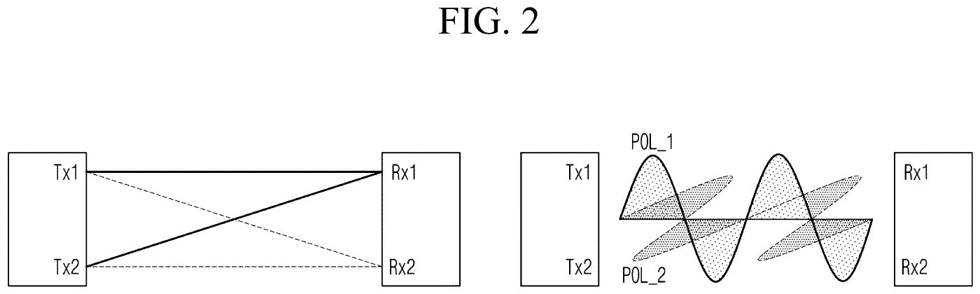

However, as in the embodiment described with reference to FIG. 5, there is a problem that partial deviation from symmetry occurs by applying the offset between the two elements in the element unit, and such symmetry problem may cause cross polarization leakage described with reference to FIG. 2.

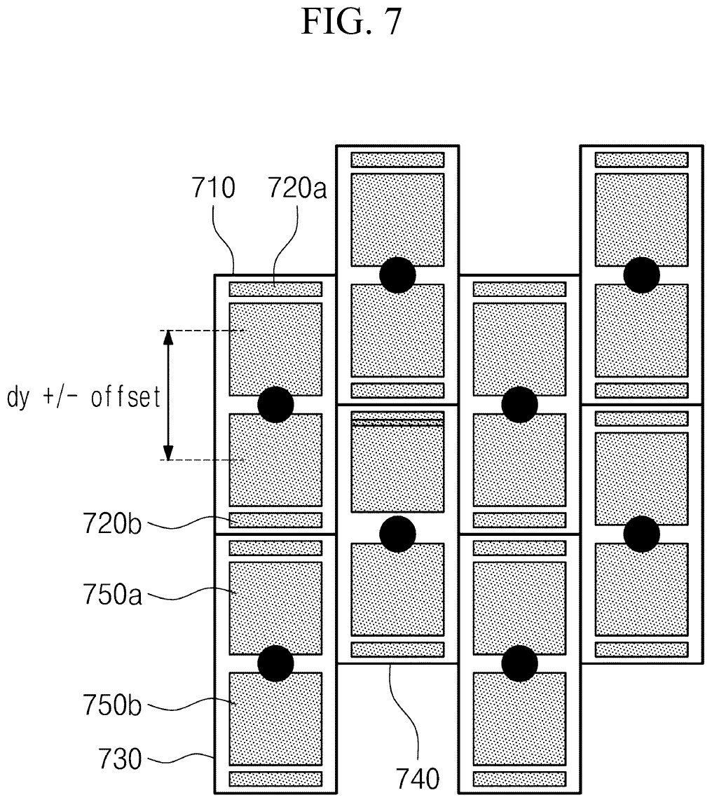

FIG. 7 is a view illustrating a structure further including a dummy patch in accordance with a preferred embodiment of the present disclosure.

The array antenna structure according to the embodiment shown in FIG. 7 is a structure configured to further include one or more dummy patches 720a and 720b configured to have no electrical signal connection, as compared to the structure of FIG. 5.

That is, as shown in FIG. 7, each of a plurality of first element units 730 disposed in a first column includes two elements 750a and 750b each having a specific distance that differs from the distance dy of one element by a predetermined value (offset), wherein each of a plurality of second element units 740 disposed in a second column adjacent to the first column may also include such two elements, and the first element units 730 and the second element units 740 may be disposed spaced apart from each other by the distance dy of one element.

The first element units 730 and the second element units 740 may be alternately and repeatedly disposed in a row direction.

Meanwhile, the present embodiment proposes reducing cross polarization leakage that occurs in the structure of the embodiment described with reference to FIG. 5, by further including the dummy patches 720a and 720b, as described above.

The dummy patches 720a and 720b may be disposed for each of the two elements in the element unit 710, and are preferably disposed at symmetrical positions per element unit 710 in the row direction, as shown in FIG. 7; however, the present disclosure is not limited thereto.

Meanwhile, the dummy patches 720a and 720b prevent cross polarization leakage occurring due to the use of a staggered via, as will be described later, as well as cross polarization leakage occurring due to element-based offset application in the element unit as shown in FIG. 5. This will be described in detail later.

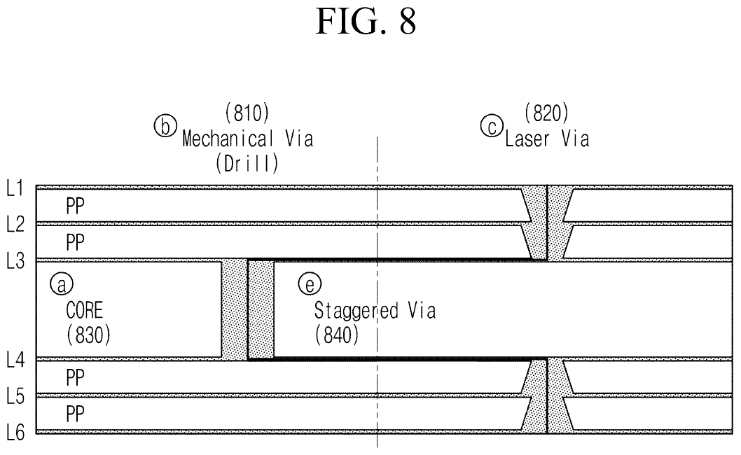

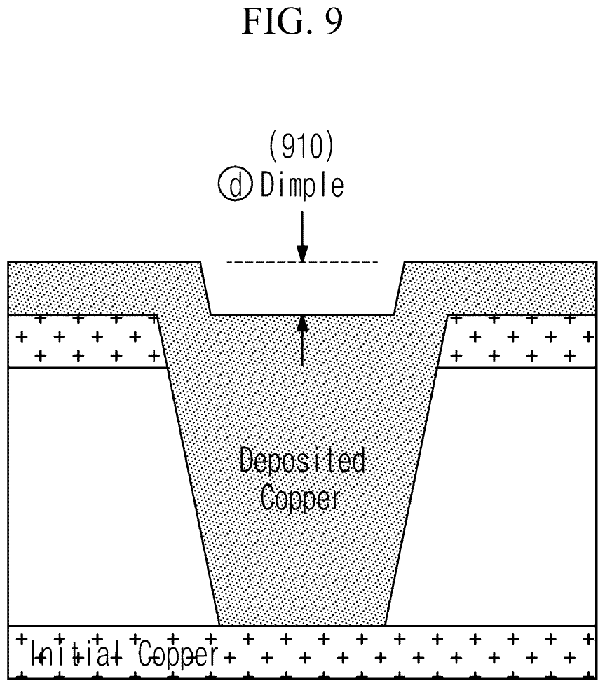

FIGS. 8 and 9 are views illustrating the reason that a staggered via is used in a PCB board for array antennas.

In the array antenna described with reference to FIGS. 3 to 5 and 7, each element/element unit may be form on a multilayer PCB. It is common for multilayer boards to use via holes for electrical signal connection between layers. Via holes are formed using various methods, and it is assumed in an embodiment of the present disclosure that a mechanical via 810 and a laser via 820 are used, as shown in FIG. 8.

Meanwhile, the multilayer board according to the embodiment of the present disclosure includes a core layer 830, as shown in FIG. 8.

The core layer 830 is the middle of a stacked PCB, and a method of adding adjacent PCB layers around the core layer 830 is most commonly used because the manufacturing cost can be reduced. That is, in forming the multilayer structure shown in FIG. 8, the present embodiment proposes to form the layers in the order of the core layer 830→L3, L4→L2, L5→ . . . .

Furthermore, it is desirable that a sufficient height be secured between a feeder and an emitter in order for the antenna to obtain emission efficiency. In order to ensure an open space of the PCB patch antenna, the core layer 830 is generally preferably designed to be thick.

Meanwhile, the mechanical via 810 is a via generally formed by drilling, which may be used when the thickness of the PCB is 0.3 t or more.

In contrast, the laser via 820 is a via hole applicable to thin PCBs, which is preferably used in antenna design for mmWave because tolerance control is better than in the mechanical via 810.

Meanwhile, FIG. 9 shows a dimple 910 formed in a via hole. The interior of the via hole is generally filled with copper, as shown in FIG. 9, and the dimple 910 may formed during the process. This may be more severe in thicker layers, and may be the reason that the staggered via 840 is formed, as shown in FIG. 8.

The staggered via 840 refers to a via located in a staggered manner, rather than being located at the same position per PCB layer, as shown in FIG. 8.

It is not possible to stack the laser via 820 directly on the mechanical via 810 of the core layer 830, which has a large thickness and therefore a high degree of dimpling, due to the dimple 910.

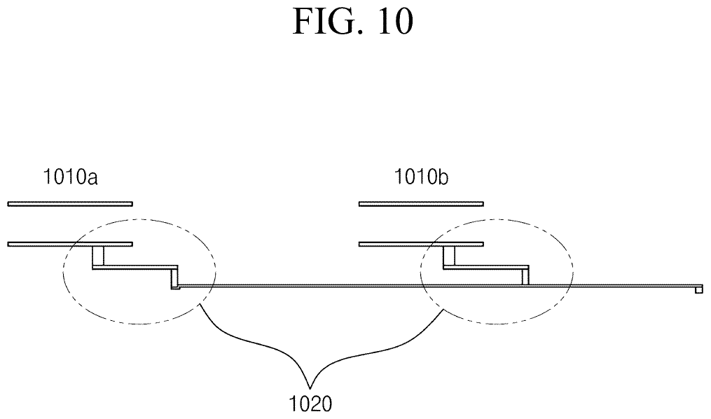

FIG. 10 is a view illustrating the reason that cross polarization leakage occurs due to the staggered via.

As described with reference to FIGS. 8 and 9, when forming a multilayer board (PCB) based on a core layer, it is necessary to use a staggered via method. FIG. 10 shows a structure in which a staggered via 1020 is formed at lower ends of patches 1010a and 1020b for connection between antenna elements of an array antenna.

The staggered via 1020 may cause discontinuous points, which may be one of the primary causes of cross polarization leakage.

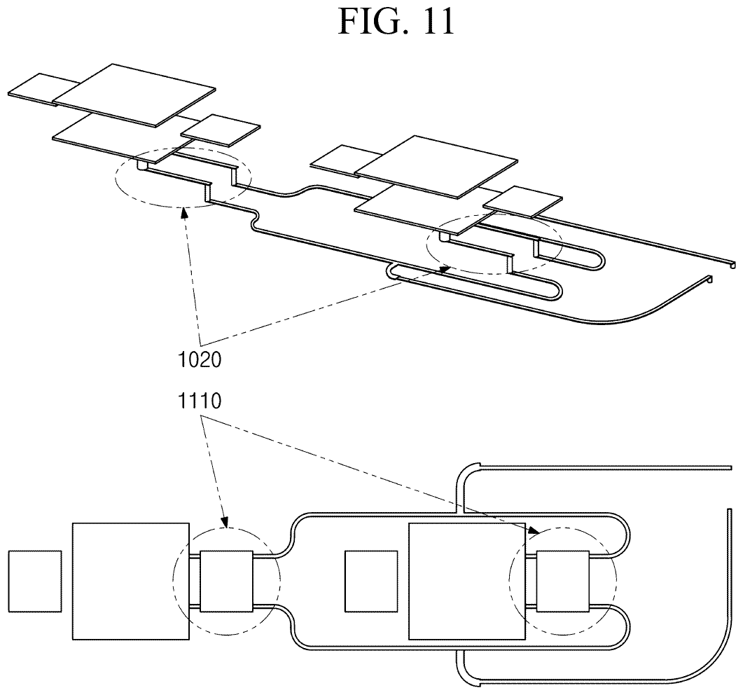

FIG. 11 is a view illustrating an antenna structure for preventing cross polarization leakage in accordance with an embodiment of the present disclosure.

First, referring to FIG. 11, discontinuous points occur due to the staggered via 1020, which results in cross polarization leakage, as described above. Accordingly, the embodiment of the present disclosure proposes a structure that reduces cross polarization leakage by adding a dummy patch 1110 having no electrical connection.

As shown in FIG. 11, the dummy patch 1110 is preferably formed so as to correspond to a planar position in which the staggered via 1020 is formed. In addition, a preferred embodiment of the present disclosure proposes to form the dummy patches 1110 in pairs that are symmetrical with respect to a patch for antenna connection on an element-by-element basis to ensure symmetry.

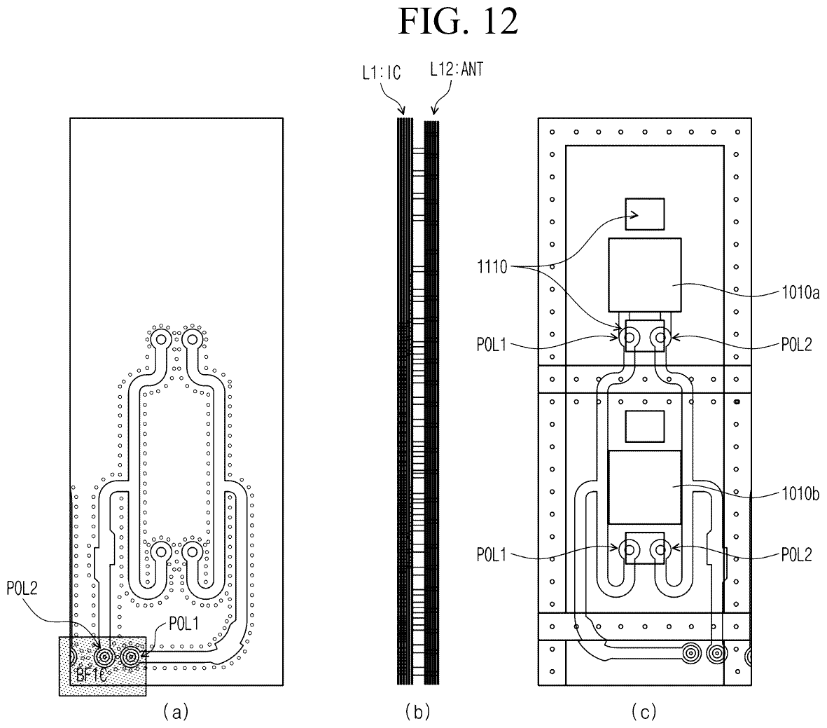

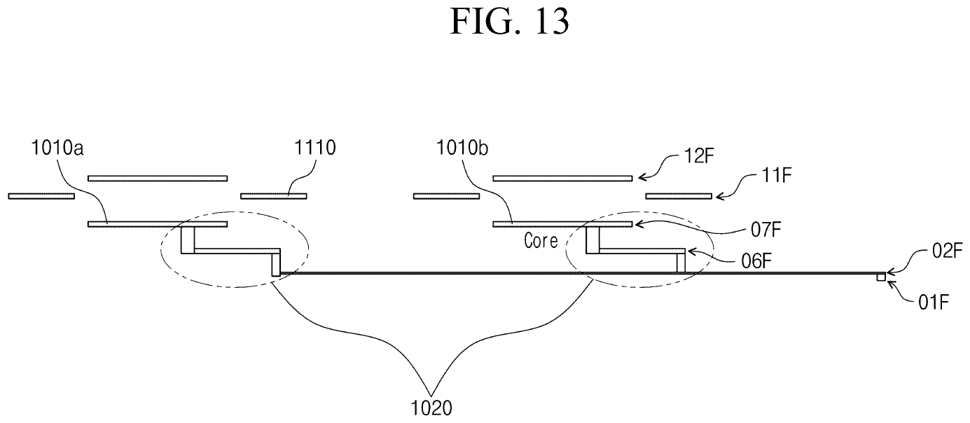

FIGS. 12 and 13 are views illustrating in detail the structure of the embodiment described in FIG. 11.

Specifically, FIG. 12(a) is a rear view of an antenna element unit, showing wiring for connection between a first polarization antenna POL_1 and a second polarization antenna POL_2 and a configuration for connecting the same to a beamforming integrated circuit BFIC.

FIG. 12(b) is a side view of the antenna element unit, in which a first layer L1 is connected to an IC, a second layer L12 is connected to an antenna, and a via is formed therebetween.

FIG. 12(c) is a front view of the antenna element unit, showing a structure in which a dummy patch 1110 is added, as described with reference to FIG. 11. As described with reference to FIG. 11, the dummy patch 1110 may be disposed at positions that are symmetrical with respect each of the patches 1010a and 1010b connected respectively to the first polarization antenna POL_1 and the second polarization antenna POL_2 to secure symmetry.

FIG. 12 shows an example in which the dummy patch 1110, which is added to prevent cross polarization leakage without electrical connection, is formed with a smaller size than each of the patches 1010a and 1010b connected to the antenna.

Meanwhile, FIG. 13 exemplarily shows the disposition relationship of the dummy patch 1110 in multiple layers.

In the example of FIG. 13, the patches 1010a and 1010b disposed for electrical signal connection to the antenna are disposed in a first layer 07F, which may be connected to one or more other second layers 01F/02F via a staggered via 1020.

The dummy patch 1110, which is disposed to prevent cross polarization leakage due to the staggered via 1020, may be formed at an upper end of the staggered via 1020 and the position symmetrical to each of the antenna connection patches 1010a and 1010b, and the example in FIG. 13 shows that the dummy patch 1110 is disposed in the third layer 11F.

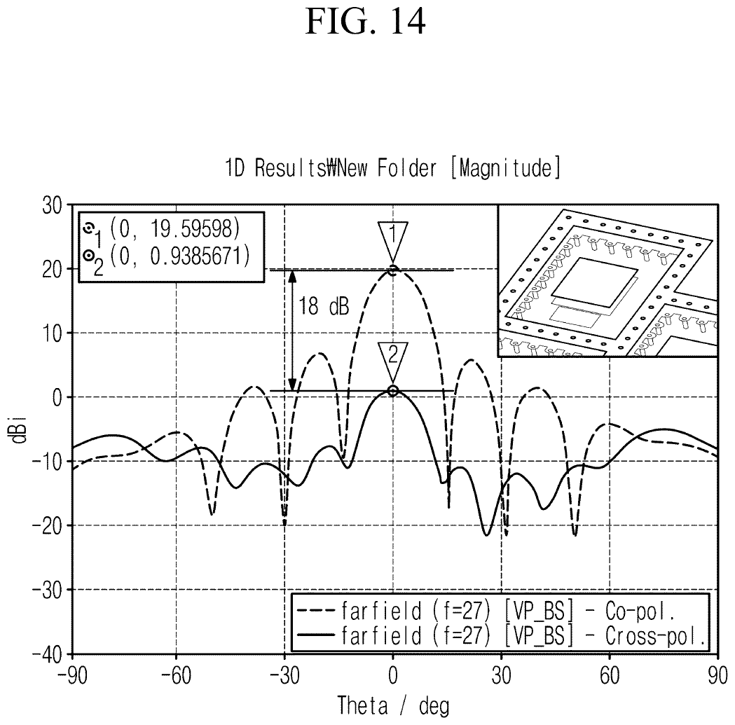

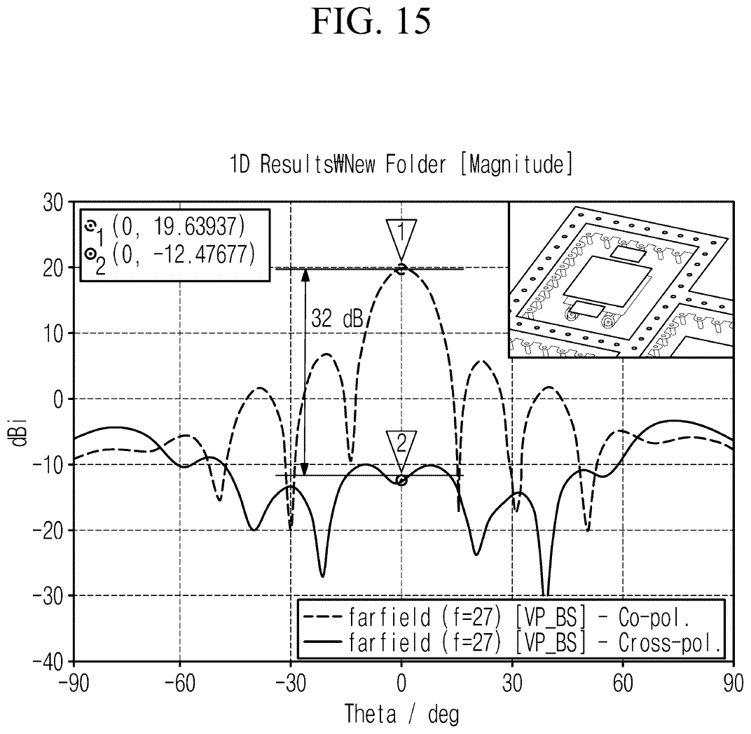

FIGS. 14 and 15 are views illustrating the effect of the structure including the dummy patch described with reference to FIG. 11.

First, FIG. 14 shows a waveform when the dummy patch described with reference to FIG. 11 is not included, and FIG. 15 shows a waveform when the dummy patch described with reference to FIG. 11 is included. In both cases, an 8×8 array antenna is used.

There is a deviation of 18 dB between the peak values of a matched polarization waveform and a cross polarization waveform when the dummy patch is not used, as shown in FIG. 14, whereas there is a deviation of 32 dB between the peak values of the matched polarization waveform and the cross polarization waveform when the dummy patch is used, as shown in FIG. 15, indicating that the dummy patch structure of FIG. 11 is effective in preventing cross polarization leakage.

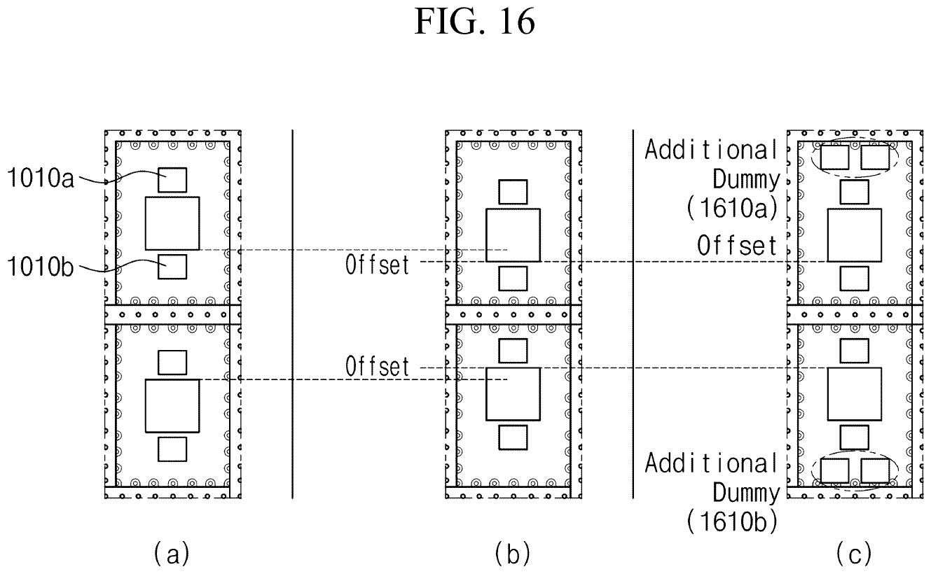

FIGS. 16 to 20 are views illustrating a structure in which the embodiment proposed through FIG. 7 is combined with the embodiment proposed through FIG. 11.

Specifically, FIG. 16(a) shows an antenna element unit constituted by two antenna elements including dummy patches 1010a and 1010b configured to prevent cross polarization leakage due to the staggered via, as in the embodiment proposed through FIG. 11.

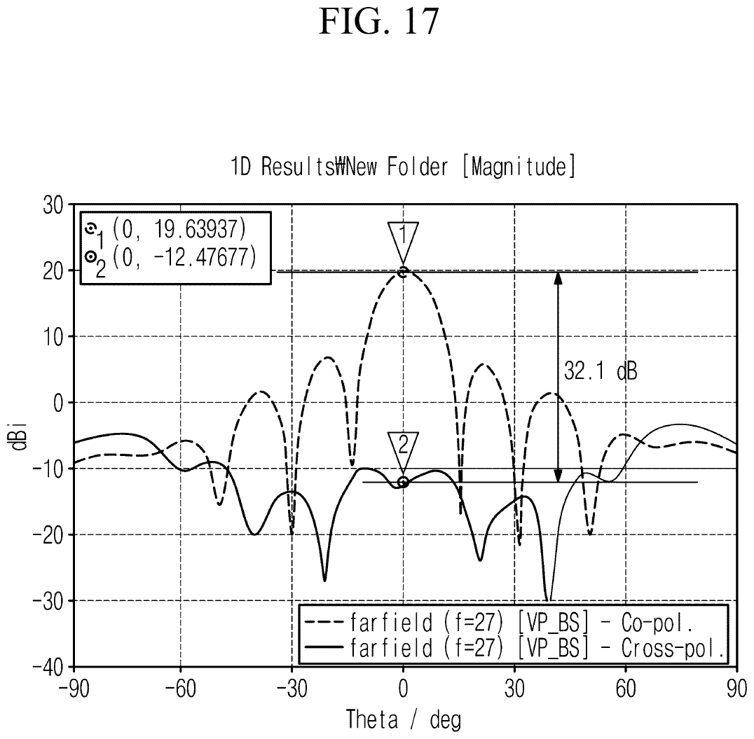

A waveform when this structure is used is shown in FIG. 17, and may have the effect of increasing the difference between the matched polarization waveform and the cross polarization waveform by 32.1 dB.

Next, FIG. 16(b) shows a structure in which the distance between the two elements in the antenna element unit is decreased by an offset in order to reduce the grating lobe, as described with reference to FIG. 5.

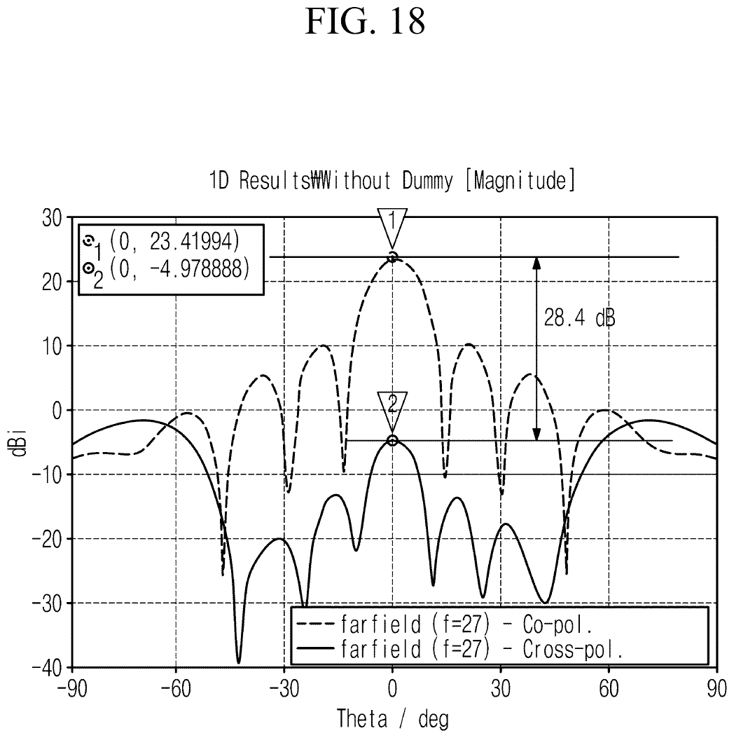

Accordingly, the grating lobe may be suppressed, as described with reference to FIG. 6, but may have the disadvantage that the difference between the matched polarization waveform and the cross polarization waveform is reduced to 28.4 dB, as shown in FIG. 18.

Finally, FIG. 16(c) shows a structure that further includes dummy patches 1610a and 1610b to prevent cross polarization leakage due to symmetry that is compromised by reducing the distance between the elements in the element unit by an offset, as in the embodiment proposed through FIG. 7.

That is, in the resulting structure of FIG. 16(c), each element may include two types of dummy patches 1010a and 1610a. The first type dummy patches 1010a are dummy patches for reducing the effects caused by the staggered via and may be symmetrical with respect to the patch for antenna connection. In addition, the second type dummy patches 1610a are dummy patches for reducing the effects of applying an offset to the distance between the elements in the element unit, and may be symmetrically disposed relative to each other on a per-antenna element unit basis, as shown in 16(c).

The first type patch 1010a and the second type patch 1610a may be formed so as to be the same size as each other to simplify manufacturing, but if desired, the second type patch 1610a may be repeatedly disposed so as to be located in the same height direction, as shown in FIG. 16(c).

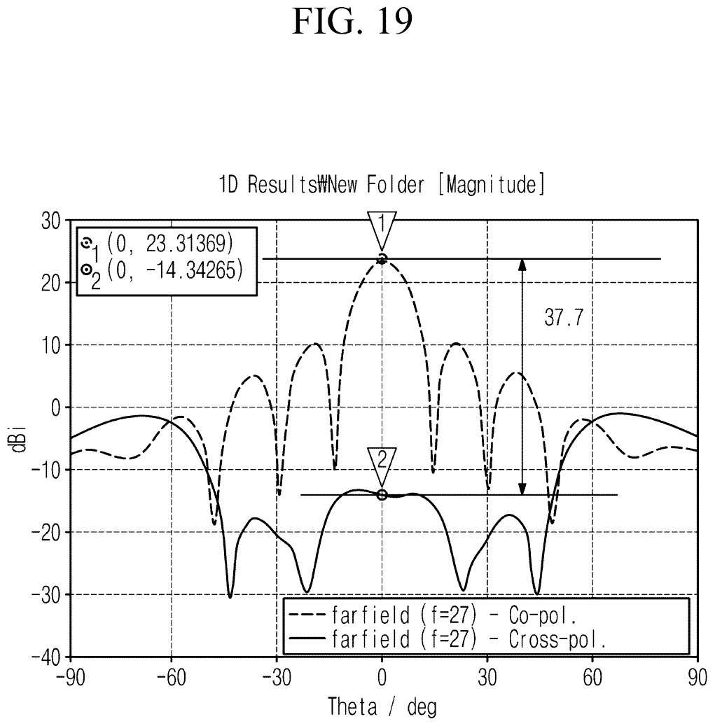

FIG. 19 shows a waveform when this structure is used, and it can be seen that the difference between the matched polarization waveform and the cross polarization waveform is increased to 37.7 dB.

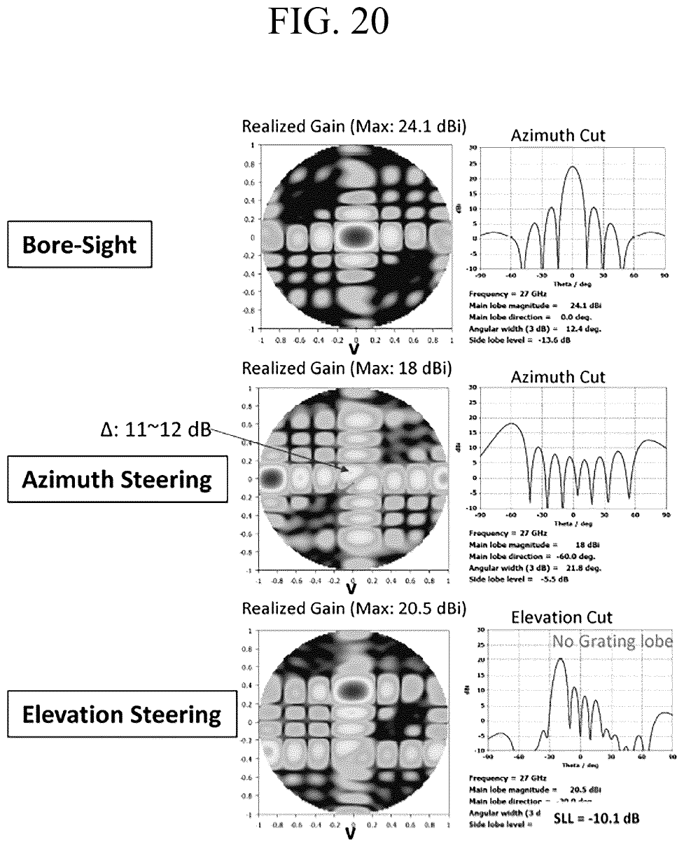

Meanwhile, FIG. 20 is a view determining whether a grating lobe occurs when the structure of FIG. 16(c) is used.

When compared to FIG. 6, it can be seen that the grating lobe in the elevation direction is suppressed, as in FIG. 6, and the azimuth steering performance is further improved.

Meanwhile, the above embodiments may be combined in a combination different from FIG. 16(c).

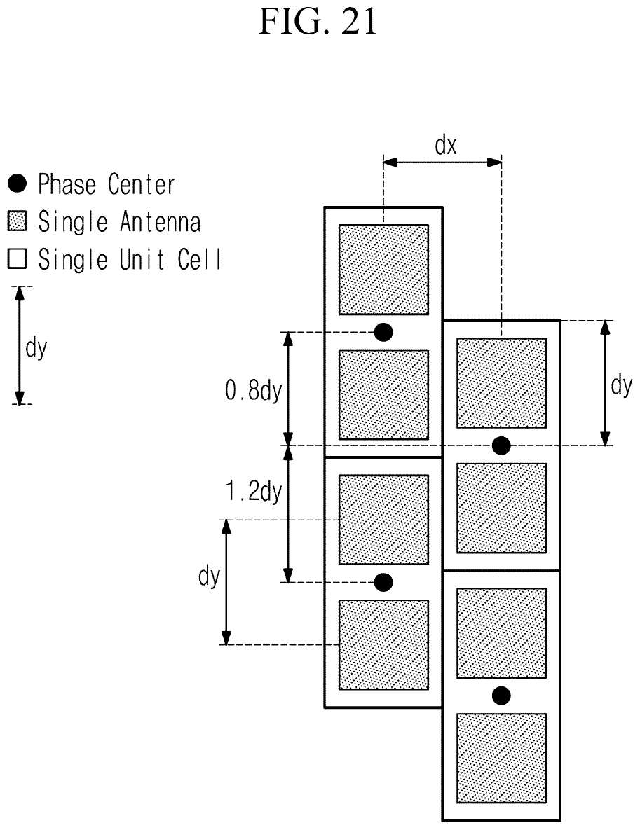

FIG. 21 is a view illustrating the concept of adjusting the distance between antenna element units in accordance with another embodiment of the present disclosure.

FIG. 21 shows an example in which, in a column direction, 0.8 dy and 1.2 dy are alternately applied as the distance between the center of an element unit disposed in a first column and the center of an element unit disposed in a second column.

In addition, the distance between two elements included in one element unit may be set so as to correspond to the distance dy of one element.

As is apparent from the above description, according to the embodiments of the present disclosure, it is possible to realize an array antenna that reduces both grating lobe and cross polarization leakage.

The effects of the present disclosure are not limited to those mentioned above, and other unmentioned effects will be clearly understood by a person having ordinary skill in the art to which the present disclosure pertains from the above description.

The array antenna for reducing the grating lobe and cross polarization leakage according to the embodiments of the present disclosure as described above may be utilized in 5G and next generation 6G communications and various other types of communication requiring beamforming.

The detailed description of the preferred embodiments of the present disclosure disclosed above has been provided to enable those skilled in the art to implement and practice the present disclosure. Although the above description has been provided with reference to preferred embodiments of the present disclosure, it will be understood by those skilled in the art that various modifications and changes can be made to the present disclosure without departing from the scope of the present disclosure. For example, those skilled in the art may utilize the configurations described in the embodiments described above in combination.

Accordingly, the present disclosure is not intended to be limited to the embodiments disclosed herein but to give the broadest scope consistent with the principles and novel features disclosed herein.

What is claimed is:

1. An array antenna comprising:
a plurality of first element units disposed in a first column, each of the plurality of first element units comprising two elements having a specific distance that differs from a distance (dy) of one element by a predetermined value; and
a plurality of second element units disposed in a second column adjacent to the first column, each of the plurality of second element units comprising two elements having the specific distance, the plurality of second element units being disposed spaced apart from the plurality of first element units by the distance (dy) of one element,
the plurality of first element units and the plurality of second element units being alternately and repeatedly disposed in a row direction, wherein
each of the first and second element units comprises one or more dummy patches configured to have no electrical signal connection.

2. The array antenna according to claim 1, wherein each of the two elements of each of the first and second element units comprises the one or more dummy patches.

3. The array antenna according to claim 2, wherein the dummy patches comprise:
first type dummy patches symmetrically disposed at positions space apart from a patch for antenna connection by a predetermined distance in a column direction in each of the two elements; and
second type dummy patches disposed symmetrically in the column direction on a per-element unit basis in each of the first and second element units.

4. The array antenna according to claim 1, wherein each of the first and second element units comprises:
a multilayer board;
a first patch disposed in at least one first layer of the multilayer board for electrical signal connection to a first polarization (POL_1) antenna and a second polarization (POL_2) antenna; and
a staggered via disposed so as to connect the first layer to at least one second layer of the multilayer board.

5. The array antenna according to claim 4, wherein the one or more dummy patches comprise a second patch spaced apart from the first patch by a predetermined distance.

6. The array antenna according to claim 4, wherein
the multiple layers comprise a core layer located between the first layer and the second layer, and
the staggered via comprises:
a first via formed in the core layer; and
a second via formed at a position spaced apart from the first via by a predetermined distance in a layer direction.

7. The array antenna according to claim 5, wherein the second patch is configured such that a difference between a waveform peak of the first polarization antenna and a waveform peak of the second polarization antenna observed at the first polarization antenna is equal to or greater than a predetermined threshold.

8. An array antenna comprising:
a plurality of first element units disposed in a first column, each of the plurality of first element units comprising two elements; and
a plurality of second element units disposed in a second column adjacent to the first column, each of the plurality of second element units comprising two elements, the plurality of second element units being disposed spaced apart from the plurality of first element units by a predetermined distance,
the plurality of first element units and the plurality of second element units being alternately and repeatedly disposed in a row direction, wherein
each of the two elements constituting each of the first and second element units comprises:
a first patch for antenna connection;
first type dummy patches symmetrically disposed at positions space apart from the first by a predetermined distance in a column direction; and
second type dummy patches disposed symmetrically in the column direction on a per-element unit basis.

9. The array antenna according to claim 8, wherein the predetermined distance corresponds to a distance (dy) of one element.

10. The array antenna according to claim 8, wherein a first distance greater by a predetermined offset than a distance (dy) of one element and a second distance less by the predetermined offset than the distance (dy) of one element are alternately applied as the predetermined distance.

11. The array antenna according to claim 8, wherein the two elements constituting each of the first and second element units are disposed spaced apart from each other by a distance that differs from a distance (dy) of one element by a predetermined value.

12. The array antenna according to claim 8, wherein the two elements constituting each of the first and second element units are disposed spaced apart from each other by a distance of one element.

13. The array antenna according to claim 8, wherein each of the first and second element units comprises a multilayer board and a staggered via.

14. The array antenna according to claim 13, wherein the first type dummy patches are configured to reduce a cross waveform between polarization antennas caused by the staggered via to a predetermined threshold or less.
